(19) United States
(12) Patent Application Publication
(10) Pub. No.: US 2023/0071543 A1
(43) Pub. Date: Mar. 9, 2023

(54) USER PLANE FUNCTION SELECTION IN A COMMUNICATIONS NETWORK

(71) Applicant: Telefonaktiebolaget LM Ericsson (publ), Stockholm (SE)

(72) Inventors: Gunnar MILDH, Sollentuna (SE); Attila MIHÁLY, Dunakeszi (HU); Paul SCHLIWA-BERTLING, Ljungsbro (SE); Göran RUNE, Linköping (SE); Gergely PONGRÁCZ, Budapest (HU)

(73) Assignee: Telefonaktiebolaget LM Ericsson (publ), Stockholm (SE)

(21) Appl. No.: 17/760,275

(22) PCT Filed: Feb. 6, 2020
(86) PCT No.: PCT/EP2020/053040

§ 371 Date: Aug. 5, 2022

(51) Int. Cl. H04W 76/22; H04W 36/12; H04W 36/00

(52) U.S. Cl. CPC H04W 76/22; H04W 36/12; H04W 36/0016

(57) ABSTRACT

One aspect provides a method performed by a radio access network node in a telecommunications network. The method comprises: responsive to detection of a trigger event associated with a wireless device having a connection to the telecommunications network via the radio access network node or seeking to establish or resume a connection to the telecommunications network via the radio access network node, selecting a core network user plane function for the connection to the telecommunications network; and initiating establishment of a user-plane tunnel for the connection between the radio access network node and the selected core network user plane function.

### TECHNICAL FIELD

Embodiments of the disclosure relate to communications networks, and particularly to methods, apparatus and computer-readable media for user plane function selection in a communications network.

### BACKGROUND

The 3GPP standardization organization has defined standards for a 5G New Radio (NR) radio interface and a 5G core network supporting communications to 5G capable wireless devices (in 3GPP called user equipments or UEs).

As part of this work, different logical nodes (or functions) are defined, including radio base stations (ng-eNBs, also known as gNBs), core network control plane nodes such as e.g. Access and Mobility Function (AMF), Session Management Function (SMF) as well as User Plane Functions (UPFs). These nodes perform certain functionality and communicate with other nodes over standardized interfaces. By defining these nodes, it is possible for vendors to build products which implement their functionality, such that operator networks support multi-vendor deployments.

The internal functional blocks as well as other details of the implementation of these nodes are left to each vendor. Similarly, it is up to each vendor if they want to implement the nodes using software components only which run on generic data center hardware or if they want to implement certain functions in dedicated hardware (or both).

In addition to logical network nodes and interfaces, 3GPP also defines signaling flows for different events occurring in 3GPP defined cellular networks. One such event is when the UE moves from one radio base station to another (e.g. handover or mobility). In this situation, the initial base station is called the “source” base station, while the new base station is called the “target” base station. When this happens there is a need to inform the UPF that the UE is now served by the target base station to ensure that the UPF sends data to the correct base station. An example signaling flow for this is shown in FIG. 1 (taken from 3GPP TS 23.502, v 16.3.0).

In this call flow the handover signaling is performed between the source and target radio access network (RAN) nodes (e.g., base stations, eNBs, gNBs and the like). Once the actual handover has occurred the target RAN node updates the AMF (see transmission of N2 Path Switch Request message), which in turn updates the SMF (see transmission of Nsmf_PDUSession_Update message), which in turn updates the UPF (see transmission of N4 Session Modification Request message). The UPF switches the downlink data to the target RAN node and also sends one or more user plane end marker packets. The source RAN node forwards the end marker packets to the target RAN node. After handover but prior to transmission of the user plane end marker packets, the source RAN node forwards any downlink data packets received from the UPF to the target RAN node for onwards transmission to the UE. The reception of the end marker packets by the target RAN node constitutes an indication that any new downlink data packets received from the UPF on the downlink path can be forwarded to the UE, and that no more data packets will be received from the source RAN node.

In the call flow shown in FIG. 1, the same UPF could serve both the target and source RAN nodes. However, depending on the type of mobility, it may happen that there is a need to change UPF to serve the target RAN node (e.g. due to the target RAN node being in a different region which does not have direct access to the original UPF). In this case, it is possible to insert an intermediate UPF (I-UPF) according to the procedure shown in FIG. 2.

The call flow shown in FIG. 2 is similar to that shown in FIG. 1, with the exception of the SMF performing a UPF selection upon receiving notification of the handover of the UE to the target RAN node from the AMF. The SMF thus selects a new I-UPF and initiates signaling to add the I-UPF in the user plane between the target RAN node and original UPF. Uplink data is thereafter transmitted from the target RAN node to the original UPF, or anchor UPF, via the I-UPF.

Thus there is a considerable delay in the handling of uplink data packets when a new UPF is selected following mobility of a UE from a source RAN node to a target RAN node. Until the new UPF (in the context of FIG. 2, the I-UPF) is selected and configured by the SMF, uplink data transmitted by the UE to the target RAN node cannot be handled by the network. Depending on the services configured for the UE, such a delay may be unacceptable. For example, so-called ultra-reliable low-latency communications (URLLC) have extremely low targets for latency in the uplink and the downlink.

### SUMMARY

Embodiments of the disclosure seek to address these and other technical problems.

In a first aspect there is provided a method performed by a radio access network node in a telecommunications network. The method comprises: responsive to detection of a trigger event associated with a wireless device having a connection to the telecommunications network via the radio access network node or seeking to establish or resume a connection to the telecommunications network via the radio access network node, selecting a core network user plane function for the connection to the telecommunications network; and initiating establishment of a user-plane tunnel for the connection between the radio access network node and the selected core network user plane function.

Apparatus and computer-readable media for performing the method of the first aspect are also provided. For example, in one embodiment the disclosure provides a radio access network node for a telecommunications network. The radio access network node comprises processing circuitry and a non-transitory computer-readable medium storing instructions, which, when executed by the processing circuitry, cause the radio access network node to: responsive to detection of a trigger event associated with a wireless device having a connection to the telecommunications network via the radio access network node or seeking to establish or resume a connection to the telecommunications network via the radio access network node, select a core network user plane function for the connection to the telecommunications network; and initiate establishment of a user-plane tunnel for the connection between the radio access network node and the selected core network user plane function.

In a second aspect there is provided a method performed by a radio access network node acting as a source radio access network node for handover of a wireless device to a target radio access node. The method comprises: transmitting a handover request message to the target radio access node, the handover request message comprising an indication of a tunnel endpoint identifier for an anchor core network user plane function associated with a session for the wireless device.

Apparatus and computer-readable media for performing the method of the second aspect are also provided. For example, in one embodiment the disclosure provides a radio access network node for a telecommunications network. The radio access network node comprises processing circuitry and a non-transitory computer-readable medium storing instructions, which, when executed by the processing circuitry, cause the radio access network node to, while acting as a source radio access network node for handover of a wireless device to a target radio access node: transmit a handover request message to the target radio access node, the handover request message comprising an indication of a tunnel endpoint identifier for an anchor core network user plane function associated with a session for the wireless device.

### BRIEF DESCRIPTION OF THE DRAWINGS

FIG. 1 is a signalling diagram showing handover without UPF re-allocation as described in 3GPP TS 23.502, v 16.3.0 (see FIG. 4.9.1.2.2-1);

FIG. 2 is a signalling diagram showing handover with insertion of an intermediate UPF as described in 3GPP TS 23.502, v 16.3.0 (see FIG. 4.9.1.2.3-1);

FIG. 3 is a flowchart of a method performed by a radio access network node according to embodiments of the disclosure;

FIG. 4 is a signalling diagram showing PDU session setup according to embodiments of the disclosure;

FIG. 5 is a signalling diagram showing mobility according to embodiments of the disclosure;

FIG. 6 is a signalling diagram showing mobility into a local breakout area according to embodiments of the disclosure;

FIG. 7 is a signalling diagram showing mobility between local breakout areas according to embodiments of the disclosure;

FIG. 8 is a signalling diagram showing mobility out of a local breakout area according to embodiments of the disclosure;

FIGS. 9 and 10 are schematic diagrams of a radio access network node according to embodiments of the disclosure;

FIG. 11 is a flowchart of a method in a source radio access network node according to embodiments of the disclosure; and

FIGS. 12 and 13 are schematic diagrams of a source radio access network node according to embodiments of the disclosure.

### DETAILED DESCRIPTION

Embodiments of the disclosure seek to address the problems noted above by introducing a UPF selection mechanism in a RAN node, such as the target RAN node involved in handover. Thus, responsive to detection of a trigger event, the RAN node selects a user plane function for a connection associated with a wireless device to the telecommunications network, and initiates establishment of a user-plane tunnel for the connection between the radio access network node and the selected user plane function. The trigger event may be associated with the wireless device having a connection to the telecommunications network via the RAN node or seeking to establish or resume a connection to the telecommunications network via the RAN node.

The trigger event may be associated with handover of the wireless device or other events (such as state transition, radio resource control (RRC) connection re-establishment after RRC connection failure). Selection of the UPF may be based on one or more policies, wireless device information, and/or other information. For example, the RAN node may first determine whether it is necessary to select a new UPF responsive to detection of the trigger event and, if so, determine which UPF to select.

By introducing a UPF selection mechanism into a RAN node, the latency of uplink communications by the wireless device can be reduced, particularly on protocol data unit (PDU) session establishment. In particular, the RAN node need no longer wait for selection of the UPF by the SMF, but may instead forward uplink data directly to the selected UPF. In addition, according to some embodiments of the disclosure, control plane signaling between the RAN and the SMF can be reduced.

A further aspect of the disclosure relates particularly to handover, and provides a method in the source RAN node of such a handover procedure. According to this method, the source RAN node provides, to the target RAN node, tunnel endpoint information for an anchor UPF for the connection of the wireless device. For example, the tunnel endpoint information may be contained in a handover request message from the source RAN node to the target RAN node.

These and other aspects of the disclosure are described in more detail below.

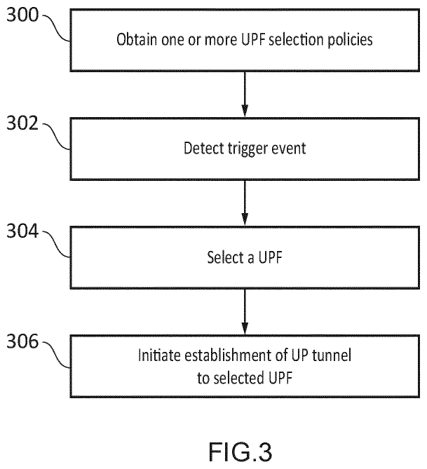

FIG. 3 is a flowchart of a method performed by a radio access network node (e.g., a base station such as an eNB, gNB, or other node within the radio access network) according to embodiments of the disclosure. In some embodiments, particularly those relating to mobility of a wireless device, the method may be performed by a radio access network node which is the target RAN node of the wireless device mobility. In other embodiments, which do not relate to mobility of a wireless device for example, the method may be performed by a serving RAN node of the wireless device.

According to some embodiments of the disclosure, selection of a UPF for a connection may be made according to one or more UPF selection policies. Accordingly, the method begins in step 300 with an optional step of obtaining one or more UPF selection policies.

The one or more UPF policies may be received from a core network node, such as the SMF, the Policy Control Function (PCF), the AMF or any other core network node. For example, the UPF policies may be signaled to the RAN node from a core network node during establishment of a Protocol Data Unit (PDU) session for a wireless device.

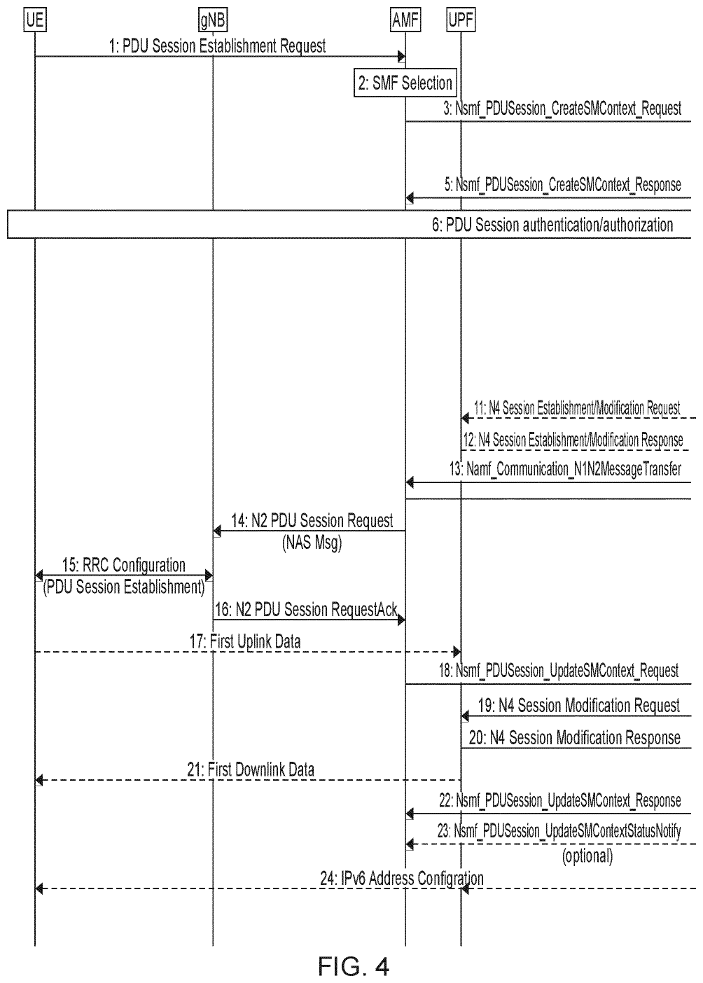

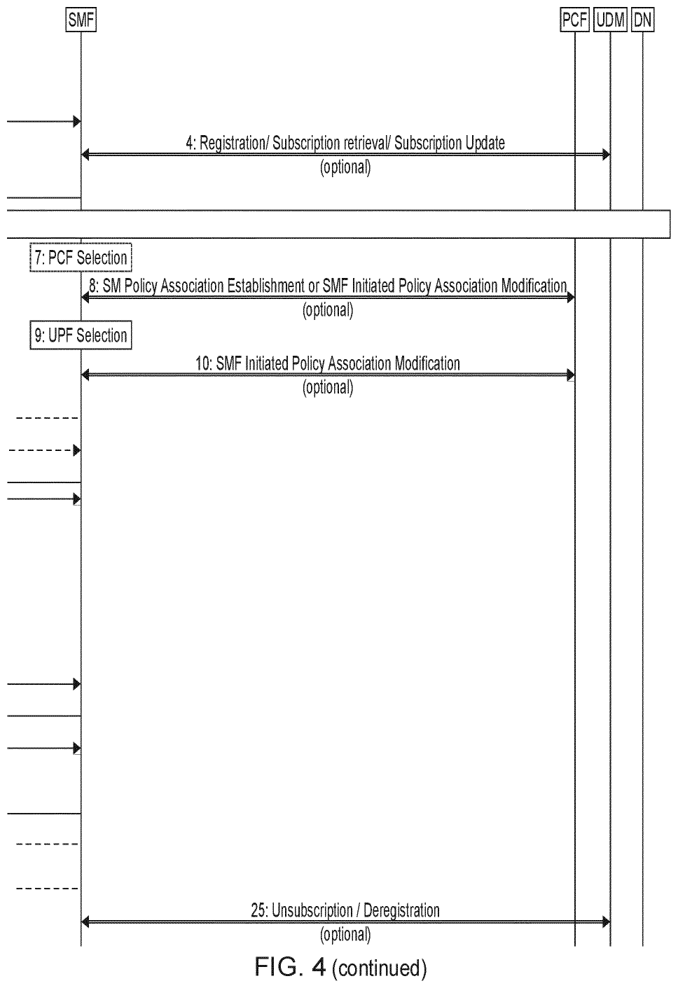

FIG. 4 is a signalling diagram showing PDU session establishment according to embodiments of the disclosure, and is taken from 3GPP TS 23.502. The detail of this signalling is not relevant for an understanding of embodiments of the disclosure, and moreover will be familiar to those skilled in the art. Therefore a detailed discussion of the signalling of FIG. 4 is omitted.

In the particular illustrated example, PDU session establishment is initiated by the UE, i.e., through transmission of a PDU Session Establishment Request message to the AMF in step 1. The principles disclosed herein are not so limited to UE-initiated PDU session establishment, however, and may straightforwardly be applied to RAN or core network initiated PDU session establishment for example. Returning to FIG. 4, and the AMF selects an SMF and requests creation of an SM context at the selected SMF in step 3 through transmission of a Nsmf_PDUSession_CreateSMContext_Request message. Thereafter, the SMF communicates with the PCF (e.g., in steps 8 and 10), and, in step 13, transmits information to the AMF to be forwarded to the RAN node (e.g., gNB in FIG. 4). In step 14, the AMF transmits information to the RAN node in an N2 PDU Session Request message. Note that this message may additionally comprise the establishment of resources for the PDU session.

The process shown in FIG. 4 may be adapted in various ways to provide for the indication of one or more UPF selection policies to the RAN node. For example, where the PCF maintains the one or more UPF selection policies referred to above, these UPC selection policies may be indicated to the SMF in one or both of the messages transmitted in steps 8 and 10, forwarded by the SMF to the AMF in step 13, and forwarded to the RAN node by the AMF in step 14. Where the SMF maintains the one or more UPF selection policies referred to above, these UPC selection policies may be indicated to the AMF in step 13, and forwarded to the RAN node by the AMF in step 14. Where the AMF maintains the one or more UPF selection policies referred to above, these UPC selection policies may be indicated to the RAN node by the AMF in step 14.

As an alternative to the embodiment shown in FIG. 4, the RAN node may obtain the one or more UPF selection policies through interactions with another function (e.g., a RAN function or a core network function) that holds or maintains the policies for the user (using an identifier for the wireless device, or an index/pointer).

In other embodiments, the one or more UPF selection policies may be provided to the RAN node from one or more other RAN nodes (e.g., during handover of the wireless device from a source RAN node to the target RAN node, or during context retrieval by a target RAN node for a wireless device which resumes a connection to the network through the target RAN node), or configured in the RAN node, e.g. by a core network node or during deployment of the network.

In yet further embodiments, one or more of these different mechanisms for informing the RAN node of the UPF selection policies may be combined, such that different mechanisms are used for indicating different types of UPF selection policy, or for indicating UPF selection policies during different procedures. In one embodiment, UPF selection policies which are static, or which are expected to remain static, may be directly configured in the RAN node at the time of its deployment in the network. For example, the RAN node may be configured to select from one or more local UPFs that are configured for local breakout of traffic. UPF selection policies which are dynamic, or expected to be dynamic, may be signaled to the RAN node by another RAN node (e.g., the source RAN node during handover of the wireless device to the RAN node performing the method) or a core network node (e.g., as described above during PDU session establishment and/or following a transition of the wireless device to an active or connected RRC state).

The one or more UPF selection policies may be indicated (e.g., by the other RAN node or core network node) by providing the full UPF selection information itself, or by an index or some other pointer to a predefined UPF selection policy or policies. The latter embodiment may be especially useful for UPF selection policies which are signaled by a source RAN node during handover, by reducing the amount of signaled bits and so providing a more efficient interface between RAN nodes. The predefined UPF selection policy or policies may be stored in the RAN node itself, or retrieved from another node such as a core network entity.

The one or more UPF selection policies may be based on one or more of the following for the wireless device: subscription information, mobility history, traffic history, network slice information, service information etc. For example, any of the subscription information, network slice information and service information may specify a particular quality of service (QoS) which is to be met by the connection. The RAN node may thus preferentially select a UPF which is able to meet the specified QoS. The mobility history of the wireless device may be used to select a UPF based on UPFs which have previously handled connections for wireless devices attached to the cells listed in the mobility history, while the traffic history may be used to select a UPF which has suitable bandwidth to meet the likely traffic demands of the connection.

The one or more UPF selection policies may comprise a rule for selection of a UPF based on the proximity of the RAN node to UPFs. For example, the RAN node may be configured to select, or to preferentially select, UPFs which are closer to the RAN node (e.g., geographically, or in terms of number of hops in the network) so as to reduce latency in the connection. The one or more UPF selection policies may comprise a rule for selecting a UPF based on previous use of UPFs for performing services associated with particular trigger events. For example, if a UPF has been used for a connection prior to handover of the wireless device to the RAN node (i.e., the trigger event is mobility of the wireless device to the RAN node), the RAN node may preferentially select that UPF for the connection. The one or more UPF selection policies may comprise a rule for selecting a UPF based on performance considerations, for the wireless device and/or the network. In the former case, the one or more UPF selection policies may comprise a rule which preferentially selects UPFs associated with relatively low latency traffic (e.g., as measured or reported previously). In the latter case, the one or more UPF selection policies may comprise a rule which selects UPFs based on load sharing (e.g., hash-based load sharing) between multiple UPFs.

Those skilled in the art will appreciate that any one or more of these UPF selection policies may be combined, and moreover may interact with each other when combined. For example, a UPF selection policy which requires the RAN node to select or preferentially select UPFs which are closer to the RAN node may introduce other conditions to be taken into consideration when selecting the UPF. For instance, if the service requires a latency below some threshold, a UPF selection policy could be introduced to select a UPF which is as close as possible to the RAN node (rather than a UPF which only just fulfils the latency requirement). In this case, the UPF selection policy based on proximity interacts with a UPF selection policy based on the cost of utilizing the UPF. Typically, the more distributed the UPF, the higher the cost. Thus the cost-based UPF selection policy interacts with the latency-based UPF selection policy to create an overall policy that selects the closest possible UPF to the RAN node. Of course, further UPF selection policies may be combined to change the overall UPF selection again.

As part of step 300, the RAN node may additionally receive information identifying those UPFs in the network which are accessible by the RAN node and/or available. The information may include, for example, logical network addresses or a range of logical network addresses for the UPFs (e.g., IP addresses or a range of IP addresses). This information may be provided to the RAN node via a domain name system (DNS) server or other database-related mechanism, or it can be signaled from the AMF, the SMF or another core network function.

Returning to a description of FIG. 3, in step 302 the RAN node determines that a trigger event associated with a wireless device is detected. The wireless device has a connection to the RAN node, or is seeking to establish or resume a connection to the RAN node. The trigger event may therefore be detected by the RAN node itself, or the RAN node may be informed that the trigger event has been detected by another node or function. Possible trigger events include PDU session establishment for the wireless device, handover of the wireless device to the RAN node, a change in the connection state of the wireless device from an inactive state to an active one (such as a transition from connection mode Idle to connection mode Connected, or a transition from RRC_INACTIVE to RRC active or CONNECTED), a change in measured key performance indicator (KPI) values for the wireless device (such as one or more KPIs falling below thresholds), connectivity problems for the wireless device, etc.

In step 304, responsive to detection of the trigger event in step 302, the RAN node selects a UPF for the connection of the wireless device. Where the RAN node received one or more UPF selection policies, e.g., in step 300 described above, the selection of the UPF may be made according to the one or more UPF selection policies. The UPF selection may be based additionally on the UPFs which are available and/or accessible to the RAN node.

In step 306, the RAN node initiates establishment of a user plane (UP) tunnel for the connection to the UPF selected in step 304.

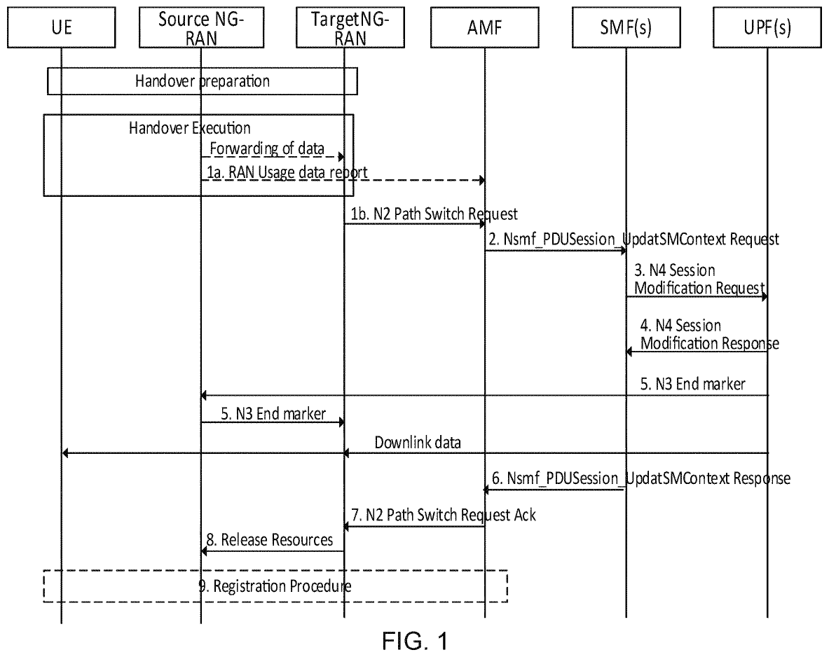

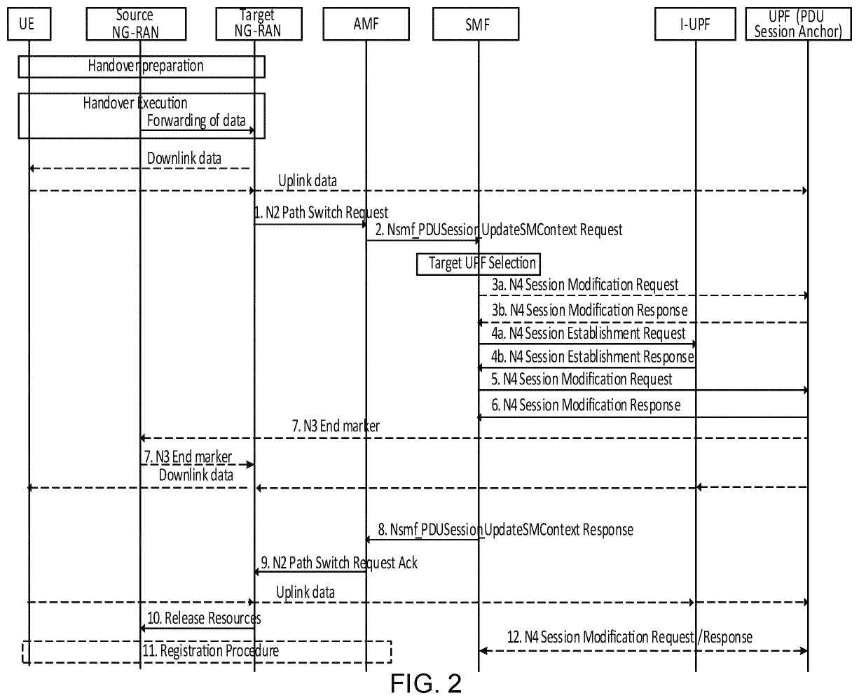

In one embodiment, the RAN node initiates establishment of the UP tunnel conventionally, by transmitting a control signal to the AMF, which in turn transmits a message to the SMF, which in turn transmits a message to the UPF as a reaction to the change signalled by the RAN node. This process is shown in FIGS. 1 and 2, described above. However, as the UPF is selected by the RAN node and not the SMF, the message transmitted by the RAN node (e.g., N2 Path Switch Request) may contain an indication of the UPF which has been selected for the session. Further, the control signalling to the AMF, SMF and UPF may take place in parallel with the transmission of uplink data packets to the new UPF, thus improving the latency of such transmissions which occur soon after PDU session establishment or handover.

In another embodiment, the RAN node initiates establishment of a UP tunnel for the connection to the selected UPF by transmitting an uplink packet directly to the selected UPF. The uplink packet may comprise a user data uplink packet, comprising user data or dummy data for the purposes of initiating the UP tunnel (e.g., a packet containing no payload, or a payload of filler bits), or a special signalling message which is nonetheless transmitted over the user plane. The transmitted packet may comprise an identifier for the PDU session (such as a tunnel endpoint identity for the wireless device for the session), to enable the selected UPF to retrieve the context for the session and trigger a mobility update for the wireless device and/or to complete the relocation of the UPF for the session from the previous UPF to the newly selected UPF.

This embodiment may utilize a new implementation architecture for logical network nodes referred to as “stateless” implementation. According to this architecture, the functions of the node are divided into “state-less” worker modules and a “stateful” data storage layer. In such an architecture the worker modules, which handle packet processing for instance, will only maintain a context for each packet processing flow temporarily, while they are working with that flow. The context can be discarded when the worker module is no longer working with that flow. Any information which needs to be maintained for future processing is instead stored in the data storage layer, which is shared between multiple worker modules.

Possible advantages with such an architecture include:
The number of worker modules can easily be scaled up at increased load conditions, since every new flow could be assigned to the worker which is least busy.
The number of worker modules can easily be scaled down at decreased load conditions, since it is possible to move a flow to another worker module using the information stored in the data storage layer.
The architecture achieves higher resilience/redundancy since if one worker “crashes” or malfunctions and needs to be restarted, it is possible to restart the processing of the flows from the information stored in the data storage layer. This can be done either by the restarted worker or by other available workers.

The architecture may further utilize a load balancing function, which assigns transactions (i.e. different processing tasks) to the worker modules. In addition to balancing the load between the plurality of worker modules, the load balancing function may seek to assign the same worker module to the same packet processing flow where possible and as long as that flow exists, such that redistribution of flows only happens when needed. In this way a worker module may not need to fetch the flow context every time a new packet arrives.

In the context of the present disclosure, the different UPFs in the network may be implemented by stateless worker modules which have access to a shared data storage layer.

The identifier for the context of the session may be assigned by the original UPF for the session or connection, with the data storage layer ensuring that the identifier is unique amongst the identifiers stored within the particular data storage layer. For example, the UPF may generate a random identifier for the session, and check with the data storage layer whether that identifier is available (i.e., not used to identify any other session with a context stored in the data storage layer). If the identifier is available, the context can be stored in the data storage layer and associated with the identifier; if the identifier is not available, a further random identifier for the session is generated by the UPF. Those skilled in the art will appreciate that various alternatives to this process exist. For example, a UPF may generate an identifier in a structured way, designed to reduce the likelihood of collision between identifiers. Each UPF may be pre-assigned a respective range of values, from which to select identifiers. In a further alternative, a UPF may pre-register a range of values with the data storage layer, guaranteed to be unique at the data storage layer. In this case the UPF need not check with the data storage layer that a particular identifier value is available before its assignment to a session, and this can reduce latency when assigning identifiers for a newly established PDU session. When pre-registering the range of values, however, the UPF may follow a similar process as described above, by generating one or more identifiers (e.g., randomly) and checking with the data storage layer when those identifiers are available.

Thus the selected UPF receives the uplink packet transmitted in step 306, and is able to retrieve the context of the PDU session or the connection from the data storage layer that it shares with the UPF which handled the PDU session or the connection previously.

Those skilled in the art will appreciate that the order of the steps described with respect to FIG. 3 may be altered without adversely affecting the functionality of the overall method. For example, in one embodiment the one or more UPF selection policies may be obtained (i.e. in step 300) after detection of the trigger event in step 302, or at the same time as detection of the trigger event. In the latter case, the RAN node may receive a message from a source RAN node indicating that handover of the wireless device is needed (i.e., the trigger event is receipt of such a message from the source RAN node), and any UPF selection policies to be applied by the RAN node in step 304 may also be indicated in the message. Similarly, the RAN may receive a message requesting establishing of a PDU session, and only thereafter (or at the same time, based on policies indicated in the message) obtain the one or more UPF selection policies to be applied.

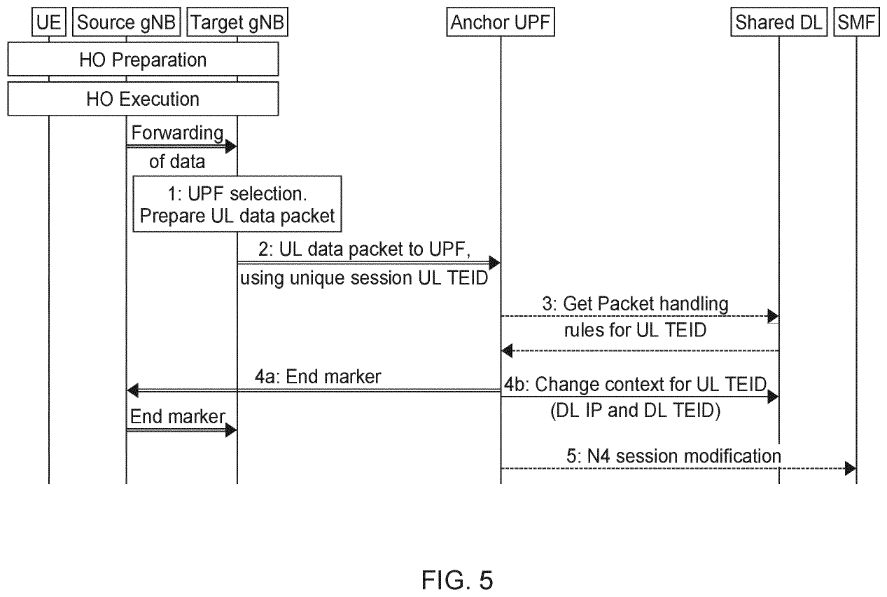

The preceding disclosure thus describes a method for selecting a UPF for a connection, performed by a RAN node. FIGS. 5 to 8 provide example implementations of this method in various mobility scenarios where the network is configured with local breakout (LBO) areas.

The following assumptions are used as an example (it being noted that none of the assumptions is a pre-requisite for the methods described herein to function effectively):
There is a UPF selection policy in the RAN node that a RAN node inside an LBO area should select from a set of available UPFs in the LBO area (that will be denoted as Uplink Classifiers (ULCLs) in the following but note that the selected UPF may also act as a PDU session anchor for the LBO traffic). Outside an LBO area, a RAN node should select from a set of available (anchor) UPFs.
There is a further UPF selection policy that any UPF identified in a Handover Request message should be preferred. That is, if the UPF identified in the Handover Request message is among those indicated as being acceptable by the UPF selection policy, the UPF identified in the Handover Request message is selected or preferred.
Each PDU session has a unique UL TEID associated and thus the UL TEID may be used by the UPFs to identify the session.
The ULCLs settings in the LBO areas are pre-configured during bootstrap time.
All (anchor) UPFs share the same data layer.

These policies are examples of UPF selection policies which may be statically configured in the RAN node.

FIG. 5 is a signalling diagram showing mobility outside of any LBO area (i.e., a wireless device moves from one RAN node to another RAN node outside any LBO area) according to embodiments of the disclosure. The signalling is thus also applicable to networks without configured LBO areas.

The wireless device (UE), source RAN node (Source gNB) and target RAN node (Target gNB) prepare and execute handover of the wireless device from the source RAN node to the target RAN node. This process may be largely conventional, with the handover being triggered by the UE or the network, based on radio measurement reports or other data.

Handover execution may comprise transmission of a Handover Request message from the source RAN node to the target RAN node. According to embodiments of the disclosure, this message may comprise an indication of a tunnel endpoint identifier for the anchor UPF associated with the connection of the wireless device prior to handover. In this context, the term “anchor UPF” is taken to mean the final UPF, furthest from the wireless device, in a series or chain of one or more UPFs configured for a connection or a session. For example, where the wireless device is configured with an intermediate UPF or ULCL for a connection or session (as shown in FIG. 2), the anchor UPF is the UPF to which the I-UPF or ULCL forwards uplink data packets. Note also that packets which are to be broken out locally are not forwarded to the anchor UPF, but are instead handled by an anchor function in the LBO area (typically the same node as the ULCL). Optionally, the Handover Request message may comprise an indication of tunnel endpoint identifiers for all of the UPFs configured for the connection or the session, i.e., any ULCLs or I-UPFs and the anchor UPF.

The different steps are described below:

In step 1, the target RAN node performs UPF selection according to the method described above with respect to FIG. 3, e.g., according to any UPF selection policies it is configured with. In this case, since it is outside any LBO areas, it has to select an anchor UPF that is reachable, and since the original anchor UPF received in the Handover Request message should be preferred, the anchor UPF is selected (here it is assumed that the handover request message comprises an indication of the tunnel endpoint identifier for the anchor UPF). The target RAN node then prepares an UL packet comprising an identifier for the session that will trigger a change of the UP path (as well as any end-marker provided via the old UP path). As noted above, this can be an UL packet sent by the UE (e.g., comprising user data), but also a dummy packet prepared by the target RAN node or a control message transmitted over the UP. A downlink TEID selected by the target RAN node is appended to the data packet, e.g., in a header, such as a GPRS Tunnelling Protocol (GTP) extension header.

In step 2, the target RAN node forwards the packet to the Anchor UPF (IP address) using its downlink tunnel endpoint address as source and using the unique UL TEID as tunnel identifier.

The Anchor UPF receives the UL packet sent by the target RAN node. The Anchor UPF may not have any packet handling rules locally cached and thus optionally, in step 3, it may fetch packet handling rules from the shared data storage layer using UL TEID.

In step 4, the Anchor UPF infers the change in context from the information in the received UL packet (i.e., the UL TEID is previously associated with a different downlink TEID). In step 4a, the Anchor UPF prepares and sends an end marker to the source RAN node on the old downlink path. In step 4b (which may be simultaneous with step 4a), the Anchor UPF makes changes to the context stored in the shared data storage layer, including updating the downlink IP address to the Target RAN node and the downlink TEID.

Optionally, in step 5, the Anchor UPF may send a message (e.g., N4 session modification request) to the SMF, notifying it about the new downlink tunnel attributes (e.g., so that the SMF can decide on possible new packet handling rules).

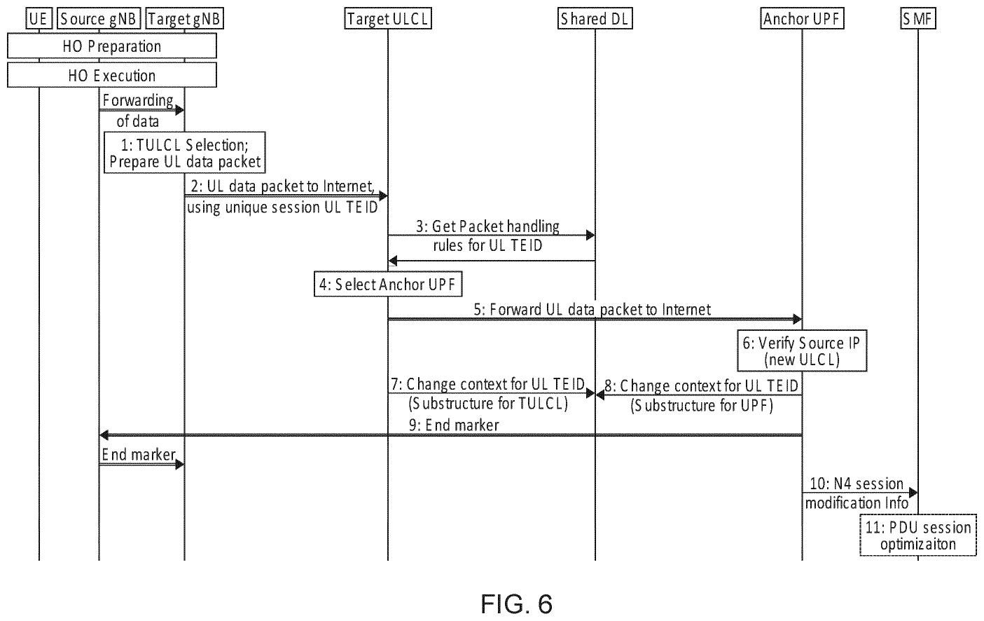

FIG. 6 is a signalling diagram showing mobility into a local breakout area according to embodiments of the disclosure. In this scenario, the Target RAN node is in a LBO area while the Source RAN node is outside the LBO area.

In the context of mobility into an LBO area, the UPF selection policy discussed above will impose the selection of an ULCL to connect to. Thus in step 1, where the target RAN node selects a UPF, a ULCL within the LBO area is selected. The UL packet is prepared by the Target RAN node in a similar way as described above with respect to FIG. 5 and sent to the Target ULCL (Step 2). The target ULCL receives the UL packet, which comprises the identifier for the session (e.g., UL TEID), and obtains the context related to the UP of this session, and also the packet handling rules for the session from the shared data storage layer (Step 3).

The ULCL is thus informed that it should act as an intermediate UPF for this session, and is also provided with the rules and information necessary to reach the Anchor UPF for the session (Step 4). It will be noted here that, if Session and Service Continuity (SSC) Mode 1 applies and there are no dynamic packet handling rules to apply, then the ULCL could also be informed implicitly of the need to act as an I-UPF by the fact that there is already an Anchor UPF present and also infer its IP address from an UL packet sent towards the Gi interface. A further alternative is that the ULCL is pre-configured with the Anchor UPF address. These alternatives do not require that the UPFs, i.e., ULCL and Anchor UPF share the same data layer.

In step 5, the ULCL forwards the received UL packet to the Anchor UPF using its own IP address as the source address. The Anchor UPF receives the packet, fetches the context from the shared data storage layer (not shown in FIG. 6), verifies the source IP address and infers that there is a new ULCL in the path (based on the changed source IP address of the UL packet). Based on the information received from the UL packet, both the ULCL and the Anchor UPF are able to setup the UL/DL paths and they also modify the context accordingly (Steps 7 and 8), i.e. to use new IP addresses and tunnel endpoint identifiers as necessary to include the ULCL. The context may contain two data substructures (i.e. one for the ULCL and one for the Anchor UPF) to avoid GTP endpoint collisions for the session with the newly introduced ULCL. In step 9, the Anchor UPF sends an end-marker to the Source RAN node via the old downlink path before removing that information from its local cache. In step 10, the Anchor UPF sends the changes to SMF via an N4 session modification request, based on which the SMF may initiate PDU session optimization (Step 11) if needed. Such PDU session optimization may comprise updating the packet handling rules, for example.

The signaling shown in FIG. 6 may also apply to the scenario in which mobility occurs within an LBO area (i.e., both the source and target RAN nodes are within the same LBO area), and there is no change to the ULCL selected for the session. This may particularly be possible where, for example, the Handover Request message comprises an indication of tunnel endpoint information for the Anchor UPF and also any ULCLs or I-UPFs in the chain of UPFs for the session. With this information, the target RAN node may thus select the same ULCL in the LBO area as previously used for the session. In this case, the context sub-structure to the Anchor UPF is not changed and therefore does not require updating in step 8. However, the Anchor UPF may still be notified by the change of context (substructure for ULCL) and could send an end-marker via the same ULCL.

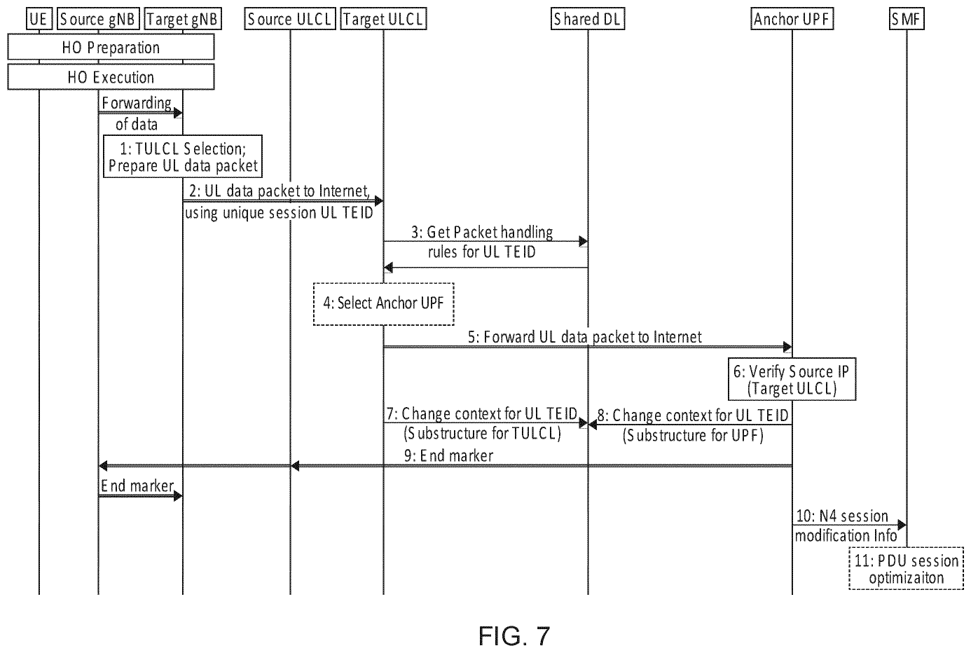

The scenario where mobility occurs between RAN nodes within the same LBO area, but a new ULCL is selected by the target RAN node (e.g., because the source ULCL is unreachable), is similar to the case where there is mobility between different LBO areas, i.e., the source RAN node is in a first LBO area and the target RAN node is in a second, different LBO area. See FIG. 7, described below.

FIG. 7 is a signalling diagram showing mobility between local breakout areas according to embodiments of the disclosure.

This case is similar to the case of mobility into an LBO area (see FIG. 6), but here the previous (Source) ULCL cannot be selected by the target RAN node as it belongs to a different LBO area. Thus a new (Target) ULCL is selected by the target RAN node in Step 1. The end marker will be sent on the old path, i.e., through the Source ULCL (Step 8).

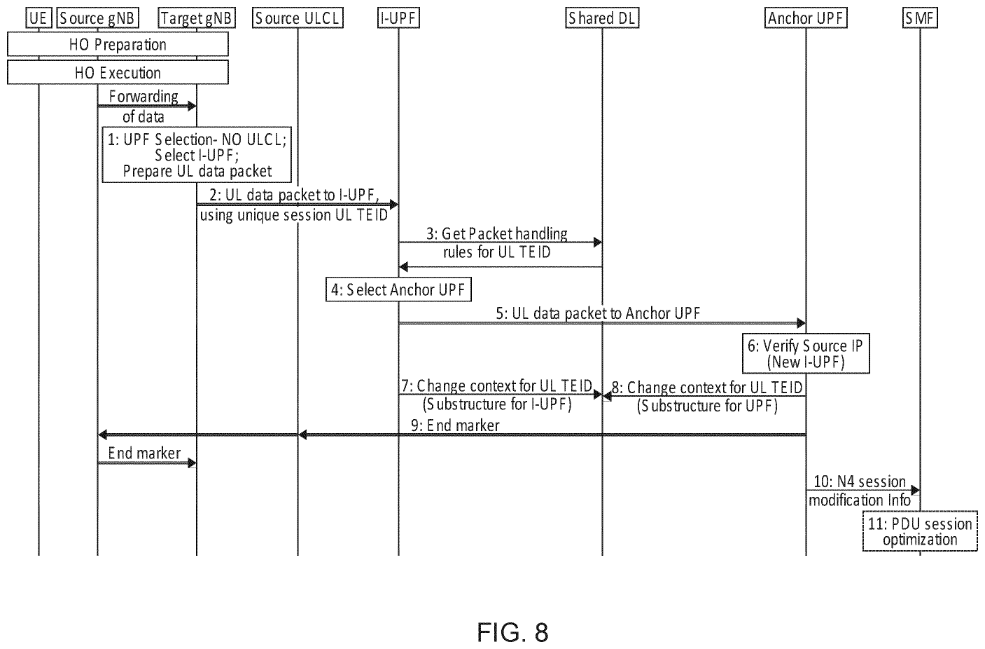

FIG. 8 is a signalling diagram showing mobility out of a local breakout area according to embodiments of the disclosure, i.e., the Source RAN node is in an LBO area and the target RAN node is not in an LBO area.

In this scenario the UE moves out of an LBO area, so there will be no ULCL for the target RAN node to select. However, the UPF received in the handover request message may comprise only the ULCL in the LBO area from which the wireless device has come. Thus there may be no information in the target RAN node allowing the Anchor UPF for this PDU session to be identified. In this case, the Target RAN node may select a UPF randomly, or according to different UPF selection policies. Thus the selected UPF may not be the Anchor UPF, and this scenario is shown in FIG. 8. The selected UPF (denoted I-UPF) is not the Anchor UPF. In this case, the target RAN node initiates connectivity setup to the I-UPF (Step 2), for example as described above with respect to step 306 in FIG. 3. The I-UPF may then obtain the context for the session from the shared data storage layer, and based on the identifier for the context in the UL packet. The tunnel endpoint identifier for the Anchor UPF may be inferred from this context, enabling the I-UPF to select the Anchor UPF in step 4 and initiate UP connection to the Anchor UPF in step 5, in a similar way to that described above with respect to FIGS. 5 to 7.

Note that the cases of mobility outside the LBO areas (e.g., as described above with respect to FIG. 5), but where the Anchor UPF is not reachable by the Target RAN node, can be handled in the same way as described in FIG. 8. In such scenarios, by virtue of the signaling described herein, N2 Handover messages such as those shown in FIG. 2 can be omitted.

In other embodiments, as noted above, the handover request message may comprise an indication of the tunnel endpoint identifier for the Anchor UPF. In this case, based on this tunnel endpoint identifier, the target RAN node can select the Anchor UPF directly, if it is reachable, and initiate connectivity to the Anchor UPF as described above with respect to step 306.

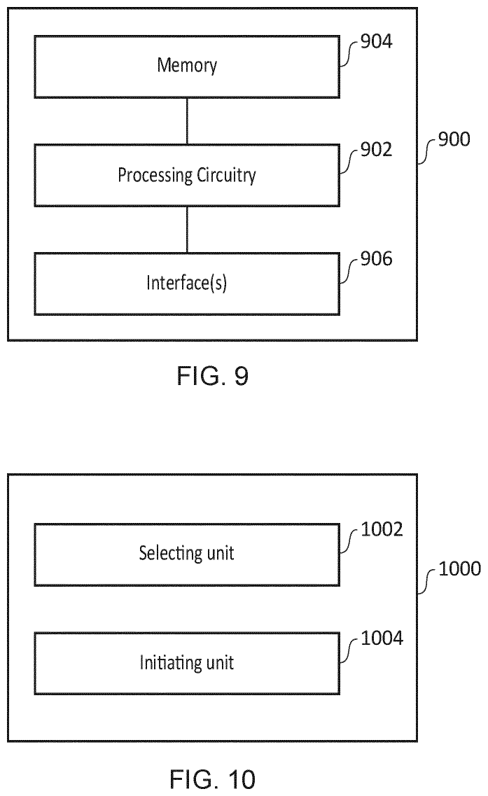

FIG. 9 is a schematic diagram of a radio access network node 900 according to embodiments of the disclosure. The radio access network node may perform the signalling and functions of the target RAN node described above with respect to one or more of FIGS. 3 to 8, for example.

The node 900 comprises processing circuitry 902 (such as one or more processors, digital signal processors, general purpose processing units, etc), a computer-readable medium (e.g., memory such as read-only memory (ROM), random-access memory, cache memory, flash memory devices, optical storage devices, etc) 904 and one or more interfaces 906. The components are illustrated coupled together in series; however, those skilled in the art will appreciate that the components may be coupled together in any suitable manner (e.g., via a system bus or suchlike).

According to embodiments of the disclosure, the computer-readable medium 904 stores instructions which, when executed by the processing circuitry 902, cause the node 900 to: responsive to detection of a trigger event associated with a wireless device having a connection to the telecommunications network via the radio access network node or seeking to establish or resume a connection to the telecommunications network via the radio access network node, select a core network user plane function for the connection to the telecommunications network; and initiate establishment of a user-plane tunnel for the connection between the radio access network node and the selected core network user plane function.

In further embodiments of the disclosure, the node 900 may comprise power circuitry (not illustrated). The power circuitry may comprise, or be coupled to, power management circuitry and is configured to supply the components of node 900 with power for performing the functionality described herein. Power circuitry may receive power from a power source. The power source and/or power circuitry may be configured to provide power to the various components of node 900 in a form suitable for the respective components (e.g., at a voltage and current level needed for each respective component). The power source may either be included in, or external to, the power circuitry and/or the node 900. For example, the node 900 may be connectable to an external power source (e.g., an electricity outlet) via an input circuitry or interface such as an electrical cable, whereby the external power source supplies power to the power circuitry. As a further example, the power source may comprise a source of power in the form of a battery or battery pack which is connected to, or integrated in, the power circuitry. The battery may provide backup power should the external power source fail. Other types of power sources, such as photovoltaic devices, may also be used.

FIG. 10 is a schematic diagram of a radio access network node 1000 according to further embodiments of the disclosure. The radio access network node may perform the signalling and functions of the target RAN node described above with respect to one or more of FIGS. 3 to 8, for example.

The node 1000 comprises a selecting unit 1002 and an initiating unit 1004. The selecting unit 1002 is configured to, responsive to detection of a trigger event associated with a wireless device having a connection to the telecommunications network via the radio access network node or seeking to establish or resume a connection to the telecommunications network via the radio access network node, select a core network user plane function for the connection to the telecommunications network. The initiating unit 1004 is configured to initiate establishment of a user-plane tunnel for the connection between the radio access network node and the selected core network user plane function.

The disclosure thus provides methods for selecting a UPF for a session or connection of a wireless device, performed by a RAN node providing that session or connection. By providing a mechanism for UPF selection in the RAN node, a new UPF can be selected for a wireless device without involving control plane signaling. This makes mobility handling for LBO scenarios simpler (as discussed above). The selection of intermediate UPFs and related functionality in the control plane can also be simplified.

A further advantage is that it separates the UP handling from the AMF/SMF functionality, which could have several advantages. It becomes possible to handle the case where the target RAN node has no connectivity to the source UPF, e.g. the request will be routed to a new UPF that may have connectivity to the anchor UPF. This may mean that an “N2 Handover” might not be needed and Xn Handover can be the only solution.

Some embodiments provide for the forwarding of packets in the uplink from the RAN node immediately to the newly selected UPF, or at least in parallel with control plane signaling, significantly reducing latency in the transmissions and thus better supporting URLLC and mission critical use cases.

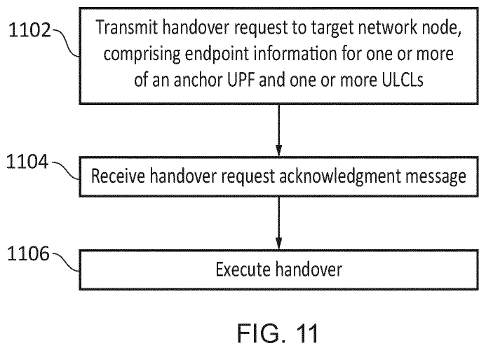

A further aspect of the disclosure, described above, relates to a method performed by a source RAN node involved in handover of a wireless device to a target RAN node. In this aspect, the source RAN node provides an indication of tunnel endpoint information (such as a tunnel endpoint identifier) for an anchor UPF associated with its connection or session to the target RAN node. Such an indication may be provided in a handover message, such as a handover request message. As noted in the description above, with respect to FIGS. 5 to 8, the provision of this information to the target RAN node allows the anchor UPF to be selected by the target RAN node for the session after handover, even in situations where the wireless device has moved out of an LBO area or where the wireless device is moving within an LBO area. This method is described in more detail below with respect to FIG. 11.

FIG. 11 is a flowchart of a method in a RAN node according to embodiments of the disclosure, in which the RAN nodes acts as a source RAN node for handover of a wireless device (e.g., a UE) to a target RAN node. In one particular embodiment, the RAN node is configured within a LBO area of a network, and thus the wireless device is configured with a chain of more than one UPF for its session with the RAN node: an anchor UPF and one or more intermediate UPFs (also termed ULCLs).

It will be understood that the method shown in FIG. 11 begins after it has already been decided to handover the wireless device from the source RAN node to the target RAN node. For example, the wireless device may have requested handover by transmitting a handover request message to the source RAN node. Alternatively, the source RAN node may have itself determined that handover of the wireless device to the target RAN node should take place, e.g., based on radio measurements reported by the wireless device.

The method begins in step 1102, in which the source RAN node transmits a handover request message to the target RAN node. The handover request message comprises an indication of a tunnel endpoint identifier for a UPF acting as the anchor UPF for the session (e.g., the PDU session) of the wireless device. The tunnel endpoint identifier may comprise a GPRS Tunnelling Protocol (GTP) tunnel endpoint identifier (TEID). Optionally, the handover request message may also comprise an indication of tunnel endpoint identifiers for any intermediate UPFs that the wireless device is configured with. As noted above, this information enables the target RAN node to select the anchor UPF for the connection or session of the wireless device after handover has been completed.

In step 1104, the RAN node receives a handover request acknowledgement message from the target RAN node.

In step 1106, the RAN node executes handover of the wireless device to the target RAN node. This step may be essentially conventional, and will not be described in significant detail herein. Those skilled in the art will appreciate that step 1106 may comprise the transmission of an RRC connection reconfiguration message to the wireless device, instructing the wireless device to handover to the target RAN node (e.g., to perform random access to establish a connection to the target RAN node).

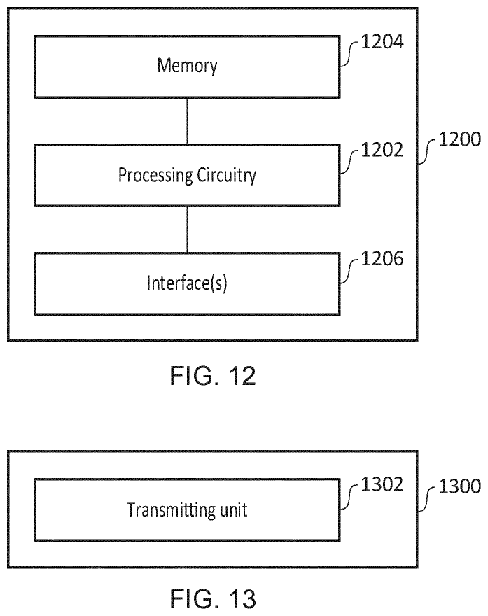

FIG. 12 is a schematic diagram of a radio access network node 1200 according to embodiments of the disclosure. The radio access network node may perform the signalling and functions of the source RAN node described above with respect to one or more of FIGS. 5 to 8, for example. The radio access network node may additionally or alternatively be configured to perform the method described above with respect to FIG. 11.

The node 1200 comprises processing circuitry 1202 (such as one or more processors, digital signal processors, general purpose processing units, etc), a computer-readable medium (e.g., memory such as read-only memory (ROM), random-access memory, cache memory, flash memory devices, optical storage devices, etc) 1204 and one or more interfaces 1206. The components are illustrated coupled together in series; however, those skilled in the art will appreciate that the components may be coupled together in any suitable manner (e.g., via a system bus or suchlike).

The radio access network node may act as a source radio access network node for handover of a wireless device to a target radio access node. According to embodiments of the disclosure, the computer-readable medium 1204 stores instructions which, when executed by the processing circuitry 1202, cause the node 1200 to: transmit a handover request message to the target radio access node, the handover request message comprising an indication of a tunnel endpoint identifier for an anchor user plane function associated with a session for the wireless device.

In further embodiments of the disclosure, the node 1200 may comprise power circuitry (not illustrated). The power circuitry may comprise, or be coupled to, power management circuitry and is configured to supply the components of node 1200 with power for performing the functionality described herein. Power circuitry may receive power from a power source. The power source and/or power circuitry may be configured to provide power to the various components of node 1200 in a form suitable for the respective components (e.g., at a voltage and current level needed for each respective component). The power source may either be included in, or external to, the power circuitry and/or the node 1200. For example, the node 1200 may be connectable to an external power source (e.g., an electricity outlet) via an input circuitry or interface such as an electrical cable, whereby the external power source supplies power to the power circuitry. As a further example, the power source may comprise a source of power in the form of a battery or battery pack which is connected to, or integrated in, the power circuitry. The battery may provide backup power should the external power source fail. Other types of power sources, such as photovoltaic devices, may also be used.

FIG. 13 is a schematic diagram of a radio access network node 1300 according to further embodiments of the disclosure. The radio access network node may perform the signalling and functions of the target RAN node described above with respect to one or more of FIGS. 3 to 8, for example.

The radio access network node may act as a source radio access network node for handover of a wireless device to a target radio access node. The node 1300 comprises a transmitting unit 1302. The transmitting unit 1302 is configured to transmit a handover request message to the target radio access node, the handover request message comprising an indication of a tunnel endpoint identifier for an anchor user plane function associated with a session for the wireless device.

The disclosure thus also provides methods and apparatus in a source RAN node during handover of a wireless device, which enable a target RAN node to select an anchor UPF for the connection of the wireless device even after handover.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-21. (canceled)

22. A radio access network node for a telecommunications network, the radio access network node comprising:
processing circuitry; and
a non-transitory computer-readable medium storing instructions, which, when executed by the processing circuitry, cause the radio access network node to:
responsive to detection of a trigger event associated with a wireless device having a connection to the telecommunications network via the radio access network node or seeking to establish or resume a connection to the telecommunications network via the radio access network node, select a core network user plane function for the connection to the telecommunications network; and
initiate establishment of a user-plane tunnel for the connection between the radio access network node and the selected core network user plane function.

23. The radio access network node of claim 22, wherein selection of the core network user plane function is based on one or more user plane function selection policies.

24. The radio access network node of claim 23, wherein the one or more user plane function selection policies are indicated in a message from a core network entity.

25. The radio access network node of claim 24, wherein the message is received from the core network entity during establishment of a protocol data unit session for the wireless device.

26. The radio access network node of claim 23, wherein the one or more user plane function selection policies are indicated in a message from a second radio access network entity.

27. The radio access network node of claim 23, wherein the one or more user plane function selection policies comprise an indication of one or more core network user plane functions that are accessible by the radio access network node.

28. The radio access network node of claim 27, wherein the indication of one or more core network user plane functions comprises a range of logical addresses for core network user plane functions that are accessible by the radio access network node.

29. The radio access network node of claim 23, wherein the one or more user plane function selection policies comprise a rule for selecting a core network user plane function based on the proximity of the core network user plane function to the radio access network node.

30. The radio access network node of claim 22, wherein the one or more user plane function selection policies comprise a rule for selecting a core network user plane function based on previous use of core network user plane functions for performing services associated with the trigger event.

31. The radio access network node of claim 23, wherein the one or more user plane function selection policies comprise a rule for selecting a core network user plane function based on a latency of communications between the core network user plane function and the radio access network node.

32. The radio access network node of claim 23, wherein the one or more user plane function selection policies comprise a rule for selecting a core network user plane function based on load sharing between multiple core network user plane functions.

33. The radio access network node of claim 22, wherein the trigger event comprises receipt of a request to establish a protocol data unit session for the wireless device.

34. The radio access network node of claim 22, wherein the trigger event comprises transition of the wireless device from an idle or inactive mode to a connected or active mode.

35. The radio access network node of claim 22, wherein the trigger event comprises receipt of a request to handover the wireless device from a source radio access network node to the radio access network node.

36. The radio access network node of claim 22, wherein initiating establishment of a user-plane tunnel comprises sending a request message to an intermediate core network entity to establish the user-plane tunnel between the radio access network node and the core network user plane function.

37. The radio access network node of claim 22, wherein initiating establishment of a user-plane tunnel comprises sending an uplink data packet to the selected core network user plane function.

38. The radio access network node of claim 37, wherein the uplink data packet comprises an identifier for a context of the connection for the wireless device.

39. A radio access network node, comprising processing circuitry and a non-transitory computer-readable medium storing instructions which, when executed by the processing circuitry, cause the radio access network node to, while acting as a source radio access network node for handover of a wireless device to a target radio access node:
transmit a handover request message to the target radio access node, the handover request message comprising an indication of a tunnel endpoint identifier for an anchor core network user plane function associated with a session for the wireless device.

40. The radio access network node of claim 39, wherein a plurality of core network user plane functions are associated with the session, the plurality of core network user plane functions comprising the anchor core network user plane function and one or more intermediate core network user plane functions.

41. The radio access network node of claim 40, wherein the handover request message further comprises an indication of tunnel endpoint identifiers for at least one of the one or more intermediate core network user plane functions.

42. (canceled)
